(19) United States
(12) Patent Application Publication
(10) Pub. No.: US 2006/0054804 A1
(43) Pub. Date: Mar. 16, 2006

(54) Method and apparatus for performing ion mobility spectrometry

(76) Inventor: Anthony S Wexler, Davis, CA (US)

Correspondence Address: A. RICHARD PARK, REG. NO. 41241;PARK, VAUGHAN & FLEMING LLP, 2820 FIFTH STREET, DAVIS, CA, 95616, US

(21) Appl. No.: 10/535,133

(22) PCT Filed: Nov. 14, 2003
(86) PCT No.: PCT/US03/36183

§ 371 Date: May 13, 2005

Related U.S. Application Data
(60) Provisional application No. 60/428,561, filed on Nov. 22, 2002.

(51) Int. Cl. B01D 59/44

(52) U.S. Cl. 250/282; 250/290

(57) ABSTRACT

One embodiment of the present invention provides a system for performing ion or particle mobility spectrometry. The system operates by first receiving a sample for analysis. Next, the system ionizes the sample and injects the ionized sample into a laminar gas flow. An electric field crosses the laminar gas flow so that the laminar gas flow and the electric field combine to spatially separate ions of the analytes based on ion mobility and so that the spatially separated ions contact different elements of an electrometer array. Next, the system analyzes the output of the electrometer array to determine the mobility of the analytes.

### BACKGROUND

1. Field of the Invention

The present invention relates to techniques for performing spectrometry to analyze the chemical composition of a material. More specifically, the present invention relates to a method and an apparatus for performing ion mobility spectrometry.

2. Related Art

Radioactive, biological, and chemical pathogens, whether natural or man-made, typically disperse in the atmosphere in particle form. However, most particulate matter in the atmosphere is non-pathogenic. Distinguishing the health effects of airborne particles involves determining both the size and the composition of these particles. The size of a particle is an indicator of the deposition pathways within airways and the probabilities of effective filtration. The composition of a particle is an indicator of the pathogenic properties of the particle.

Various instruments are available for real-time analysis of potential pathogenic compounds in atmospheric aerosol particles. For example, one type of instrument uses fluorescence with an aerodynamic particle sizer to detect biological materials in the atmosphere. This instrument aerodynamically sizes particles and reports which ones fluoresce, thereby indicating biological origin. Unfortunately, this test is non-specific because all biological materials fluoresce, consequently this test generates a large number of false positives.

A common and popular way to analyze the chemical composition of airborne materials is with ion mobility spectrometry (IMS) since it can be made to operate in real-time, can be made portable, and can distinguish many potentially harmful compounds, such as explosives and toxins, from benign ones. While effective in some instances, IMS is limited because of low sensitivity and/or low resolution.

FIG. 1 illustrates a conventional ion mobility spectrometer 108. During operation, a gas-phase sample 102 is provided to ionizer 104. Ionizer 104 is typically a Ni⁶³ source; however any one of a number of well-known ionizing materials and techniques can be used. Ionizer 104 ionizes the analyte or analytes within sample 102.

Sample 102 (including the ionized analyte) is then passed through gate 106. Gate 106 typically includes a shutter that selects a given portion of sample 102 and passes this portion into ion mobility spectrometer 108. Ion mobility spectrometer 108 provides an electric field 112 that runs parallel to and in the direction of travel of the selected portion of sample 102. Ion mobility spectrometer 108 also provides a gas flow 114 in the direction opposite the direction of travel of the selected portion of sample 102. The gas used for gas flow 114 should ideally be dry and should ideally include no ions.

Electric field 112 accelerates the ions within the selected portion of sample 102. Note that electric field 112 can be reversed. This allows anions and cations to be selectively analyzed by selecting the direction of electric field 112. Gas flow 114 slows the ions according to size and aerodynamic drag. The smaller ions pass through ion mobility spectrometer 108 more quickly while the larger ions pass more slowly. Operating together, electric field 112 and gas flow 114 separate the ions in time. Detector 116, which typically is an electrometer, is reset so as to be synchronized with gate 106. The output of detector 110 provides a signal indicating output amplitude versus time. Each ion that reaches detector 110 provides an increment of amplitude at the time when the ion reaches detector 110. After all of the ions have reached detector 110, the output signal is analyzed to determine the chemical composition of sample 102. This analysis process can be performed using any one of a number of well-known techniques.

Drawbacks to the above-described technique for performing IMS include low sensitivity and/or low resolution resulting from gate 106. If gate 106 is made small so it selects a small sample, the resolution of ion mobility spectrometer 108 is high at the expense of sensitivity. A small sample includes a limited amount of analyte leading to the low sensitivity. On the other hand, increasing the size of gate 106 and selecting more analyte yields greater sensitivity at the expense of resolution.

Hence, what is needed is a method and an apparatus for performing ion mobility spectrometry without the problems described above.

### SUMMARY

One embodiment of the present invention provides a system for performing ion or particle mobility spectrometry. The system operates by first receiving a sample for analysis. Next, the system ionizes the sample and injects the ionized sample into a laminar gas flow. An electric field crosses the laminar gas flow so that the laminar gas flow and the electric field combine to spatially separate ions of the analytes based on ion mobility and so that the spatially separated ions contact different elements of an electrometer array. Next, the system analyzes the output of the electrometer array to determine the mobility of the analytes.

In a variation of this embodiment, receiving the sample for analysis involves receiving particles for analysis and converting the particles into the gas-phase.

In a further variation, converting the particles into the gas-phase involves desorbing analytes from the particles.

In a further variation, converting the particles into the gas-phase involves ablating analytes from the particles.

In a further variation, individual charged particles are detected by the electrometer array providing particle mobility information.

In a further variation, the system analyzes the sample with two ion mobility spectrometers in tandem. The first ion mobility spectrometer receives ions that have been desorbed from the analytes, and the second ion mobility spectrometer receives ions that have been ablated from the analytes. In this way, the first ion mobility spectrometer analyzes volatile compounds in the sample, and the second ion mobility spectrometer analyzes non-volatile compounds in the sample.

In a further variation, reading the output of the electrometer array involves first resetting the electrometer array so that a charge on each element of the electrometer array is substantially zero. Next, the system accumulates charge on elements of the electrometer array for a given time. The system then reads the charge on each element of the electrometer array.

In a further variation, the sample is in a particle phase, and the laminar gas flow and the electric field are adjusted to separate particle mobilities.

In a further variation, performing ion mobility spectrometry involves using a separate electrometer array for positive ions and a separate electrometer array for negative ions.

In a further variation, the electric field runs substantially perpendicular to the direction of the laminar gas flow.

### BRIEF DESCRIPTION OF THE FIGURES

FIG. 1 illustrates an ion mobility spectrometer.

FIG. 2 illustrates an ion mobility spectrometer in accordance with an embodiment of the present invention.

FIG. 3 illustrates gas flow in an ion mobility spectrometer in accordance with an embodiment of the present invention.

FIG. 4A illustrates exemplary dimensions for an ion mobility spectrometer in accordance with an embodiment of the present invention.

FIG. 4B dimensions of an ion mobility spectrometer in accordance with an embodiment of the present invention.

FIG. 5 illustrates a desorber for converting a particle to gas-phase in accordance with an embodiment of the present invention.

FIG. 6 illustrates an ablator for converting a particle to gas-phase in accordance with an embodiment of the present invention.

FIG. 7 illustrates a particle detector used in conjunction with conversion to gas-phase in accordance with an embodiment of the present invention.

FIG. 8 illustrates a particle detector used in without conversion to gas-phase in accordance with an embodiment of the present invention.

FIG. 9 illustrates the process of analyzing volatile and non-volatile compounds in accordance with an embodiment of the present invention.

FIG. 10 illustrates the process of simultaneously detecting anions and cations in accordance with an embodiment of the present invention.

FIG. 11 is a flowchart illustrating the process of analyzing a gas-phase sample in accordance with an embodiment of the present invention

FIG. 12 is a flowchart illustrating the process of adjusting the ion mobility spectrometer in accordance with an embodiment of the present invention.

FIG. 13 is a flowchart illustrating the process of continuously converting particles to a gas-phase for analysis in accordance with an embodiment of the present invention.

FIG. 14 is a flowchart illustrating the process of converting a single particle to a gas-phase in accordance with an embodiment of the present invention.

FIG. 15 is a flowchart illustrating the process of analyzing the mobility of particles in accordance with an embodiment of the present invention.

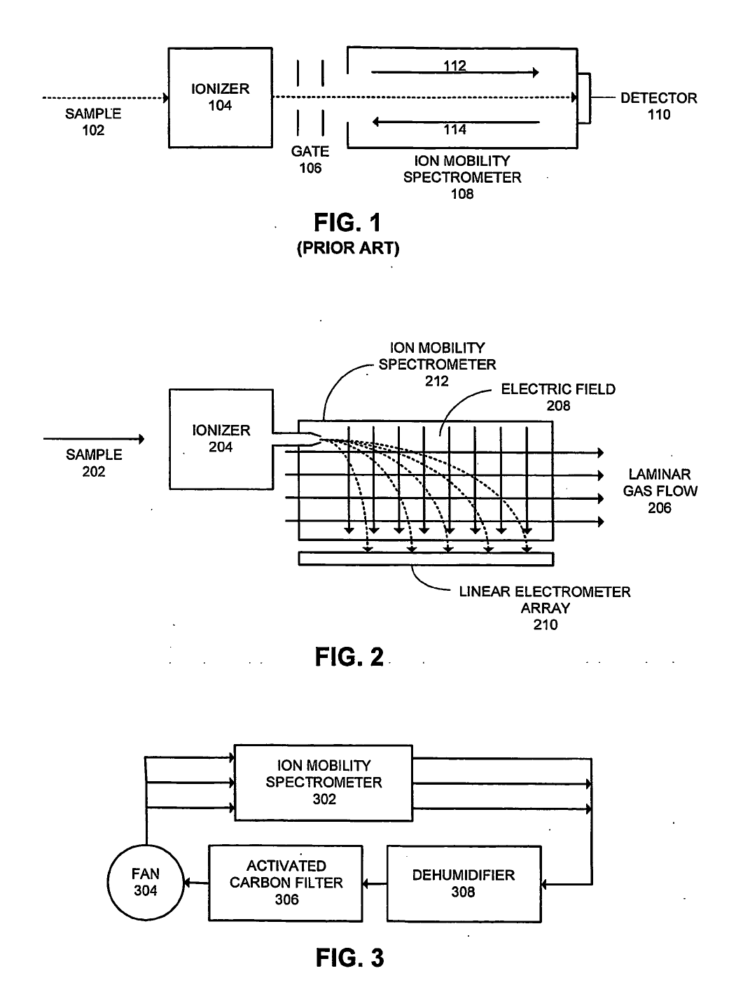

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Ion Mobility Spectrometer

FIG. 2 illustrates an ion mobility spectrometer 212 in accordance with an embodiment of the present invention. During operation, a gas-phase sample 202 is provided to ionizer 204. Ionizer 204 is typically a Ni⁶³ source; however any one of a number of well-known ionizing materials and techniques can be used. Ionizer 204 ionizes the analyte or analytes within sample 202.

Ionizer 204 continuously injects the ionized sample into ion mobility spectrometer 212 through an injection needle. Ion mobility spectrometer 212 includes a laminar gas flow 206 in the direction of the injection. The gas within laminar gas flow 206 is ideally dry and includes no ions. Ion mobility spectrometer 212 also includes an electric field 208, which crosses laminar gas flow 206. Note that the angle of crossing can be other than ninety degrees as shown in FIG. 2.

Laminar gas flow 206 causes ions with larger aerodynamic area to move faster than ions with small aerodynamic area. Electric field 208 causes ions to be deflected toward linear electrometer array 210. Note that the polarity of electric field 208 can be reversed to select between anions and cations. The combined effects of laminar gas flow 206 and electric field 208 cause the ions to strike linear electrometer array 210 at different locations depending on the aerodynamic area and charge of the ion. This differentiates ions of the analyte over space.

Linear electrometer array 210 includes a large number of electrometers—possibly 1000-2000—that are sensitive to the ions. During operation, each electrometer in linear electrometer array 210 is first reset so that the output of the electrometer is essentially zero. Charge from the ions is allowed to accumulate on the electrometers for a given time and then the electrometers are read to determine the charge on each electrometer. This reading provides an indication of the number of ions that struck each electrometer of linear electrometer array 210. The resulting data is then analyzed to determine the chemical composition of the analyte or analytes. The analysis can be accomplished by comparing the data with data recorded using known samples.

Gas Flow

FIG. 3 illustrates gas flow in an ion mobility spectrometer in accordance with an embodiment of the present invention. To ensure proper operation, it is desirable for laminar gas flow 206 to be laminar, clean, and have controlled humidity. This is accomplished by keeping the Reynolds number at or below 1000. Higher Reynolds numbers can be used if care is taken to ensure a laminar flow.

Laminar gas flow can be provided by a fan as shown in FIG. 3 or can be provided by a pressurized gas source using a gas such as argon or helium. The system shown in FIG. 3 uses fan 304 to move the gas (air) through ion mobility spectrometer 302. Fan 304 is operated to provide a laminar flow of gas within ion mobility spectrometer 302. Dehumidifier 308 effectively removes water molecules from the air flowing through the system. Since water molecules are polar, they tend to attach to the ions thereby causing increased aerodynamic surface area and incorrect results. Activated carbon filter 306 removes any existing ions in the air stream to prevent them from causing incorrect results.

Dimensions

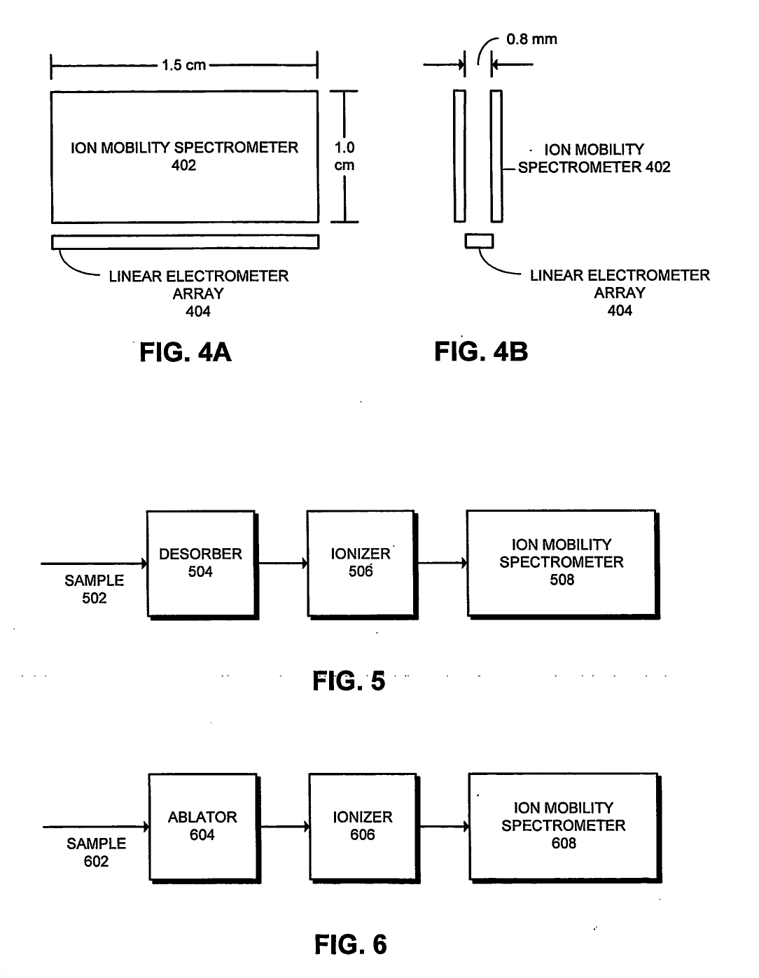

FIG. 4A illustrates exemplary dimensions for an ion mobility spectrometer 402 in accordance with an embodiment of the present invention. The length of ion mobility spectrometer is chosen to match linear electrometer array 404. This length is on the order of 1.5 cm. The height of ion mobility spectrometer 402 can be approximately 1.0 centimeters. This height is chosen based on associated parameters of electric field 208 and laminar gas flow 206 to provide adequate dispersal of the ions over linear electrometer array 404.

FIG. 4B provides a cross-sectional view of ion mobility spectrometer 402 in accordance with an embodiment of the present invention. The sides of ion mobility spectrometer 402 are closely spaced (on the order of 0.8 mm). This spacing is chosen based on parameters of laminar gas flow 206 to provide an adequate laminar flow rate to provide good separation of the ions at linear electrometer array 210 without turbulence. Note that electric field 208, which is established on the side walls of ion mobility spectrometer 402, is ideally the same on both walls. If the field is not the same on both walls, the ions may be deflected into one wall or the other and will not contact linear electrometer array 404.

Desorber

FIG. 5 illustrates a configuration of a system that includes a desorber 504 for converting a particle into a gaseous state in accordance with an embodiment of the present invention. Sample 502 is provided to desorber 504. Desorber 504 converts volatile components of particles into a gaseous state before entering 506. Desorber 504 can be a thermal device or any other device which will cause the volatile material in a particle to desorb. Ionizer 506 and ion mobility spectrometer 508 operate as described above.

Ablator

FIG. 6 illustrates a configuration of a system that includes an ablator 604 for converting a particle into a gaseous state in accordance with an embodiment of the present invention. Sample 602 is provided to ablator 604. Ablator 604 converts components of particles into a gaseous state before entering ionizer 606. Ablator 604 can use a laser or any other device which will cause the non-volatile material in a particle to be ablated. Ionizer 606 and ion mobility spectrometer 608 operate as described above.

Particle Detector

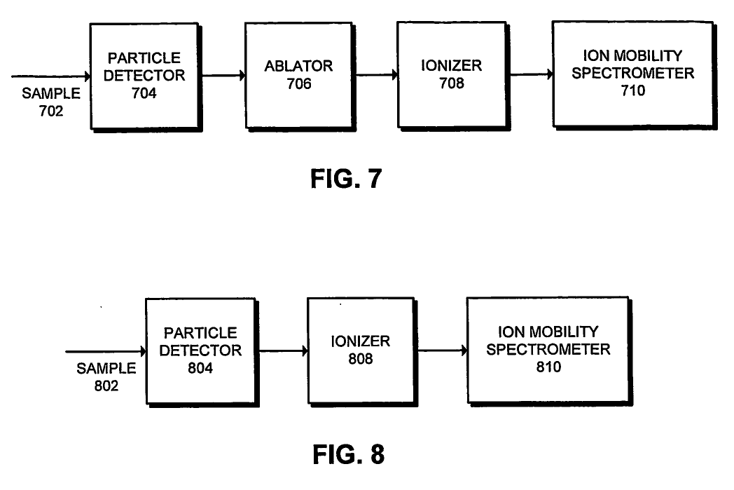

FIG. 7 illustrates a configuration of a system that includes a particle detector 704 used in accordance with an embodiment of the present invention. Particle detector 704 operates by detecting diffraction caused by a particle in sample 702 passing through a laser beam. When a particle is detected, the linear electrometer array associated with ion mobility spectrometer 710 is reset. The particle then passes through ablator 706 where the particle is converted into a gaseous state. Note that ablator 706 can be replaced with a desorber to analyze volatile particles. Ionizer 708 and ion mobility spectrometer 710 operate as described above. Note that since particle detector 704 detects a particle and resets the linear electrometer array, analysis of the composition of a single particle is possible.

Non-Gas Phase Particle Analysis

FIG. 8 illustrates a configuration of a system that includes a particle detector 804 used without conversion to gas-phase in accordance with an embodiment of the present invention. Particle detector 804 detects diffraction caused by a particle in sample 802 passing through a laser beam. When a particle is detected, the linear electrometer array associated with ion mobility spectrometer 810 is reset. The particle is passed directly into ionizer 808 without converting the particle to gas-phase. The laminar gas flow and electric field are adjusted to provide separation of different ionized particles within ion mobility spectrometer 810. Note that this configuration provides particle mobility analysis.

Simultaneous Analysis of Volatile and Non-Volatile Compounds

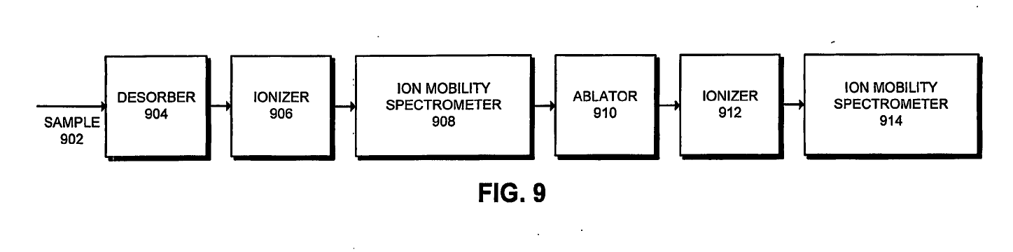

FIG. 9 illustrates a system that analyzes volatile and nonvolatile compounds in accordance with an embodiment of the present invention. Sample 902 is fed through to desorber 904, which converts volatile compounds in the particle to a gas-phase. The gaseous compounds and the remaining non-volatile portions of the particle are fed through to ionizer 906. Ionizer 906 and ion mobility spectrometer 908 operate as described above and provide an analysis of the volatile compounds. The non-volatile portions of the particle are provided to ablator 910 where they are converted to a gas-phase. These gaseous compounds are then sent to ionizer 912. Ionizer 912 and ion mobility spectrometer 914 operate as described above and provide an analysis of the non-volatile portions of the particle.

Simultaneous Analysis of Anions and Cations

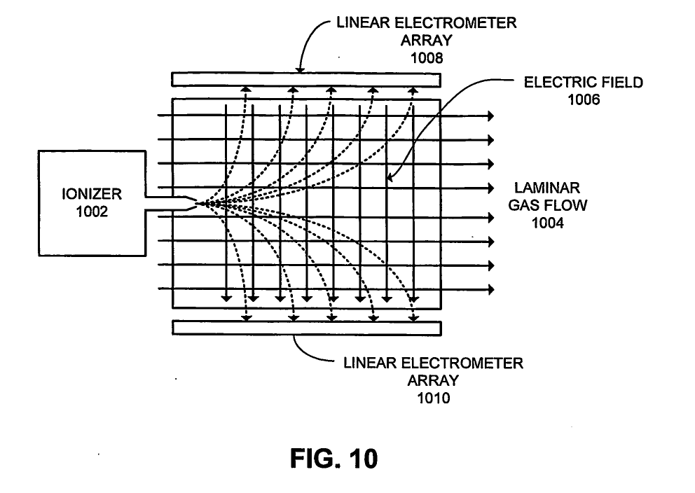

FIG. 10 illustrates a system that simultaneously detects anions and cations in accordance with an embodiment of the present invention. The ionized sample provided by ionizer 1002 is passed into an ion mobility spectrometer which includes linear electrometer arrays 1008 and 1010. Laminar gas flow 1004 is established as described above. Electric field 1006, however, provides a field that moves anions and cations in opposite directions. Thus, the ion mobility spectrometer can analyze both the cations and the anions simultaneously. This is particularly important when analyzing a single particle. If the cations and anions are not analyzed simultaneously, one or the other will be lost.

Analyzing a Gas Phase Sample

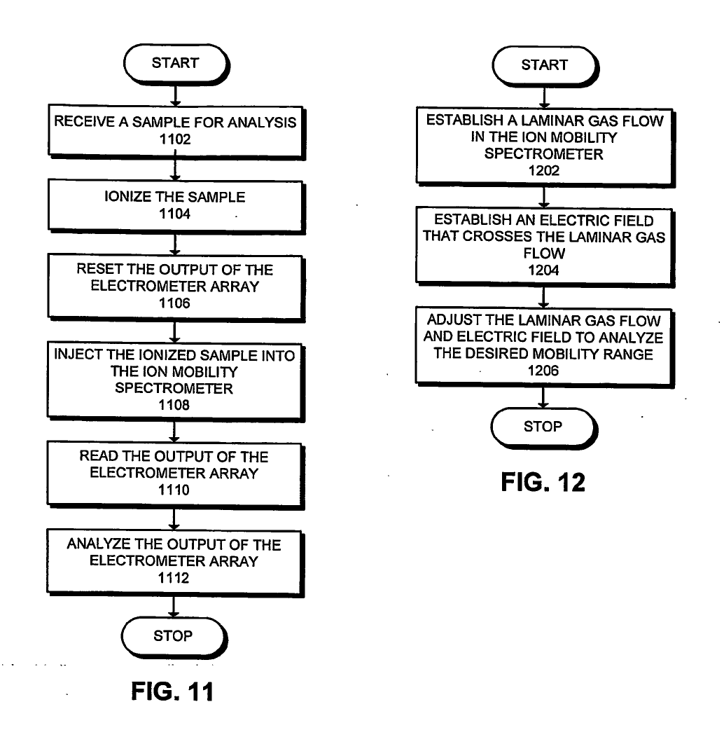

FIG. 11 is a flowchart illustrating the process of analyzing a gas-phase sample in accordance with an embodiment of the present invention. The system starts when a sample is received for analysis (step 1102). Next, the system ionizes the sample (step 1104). The system then resets the output of the electrometer array so that the output is substantially zero (step 1106).

Next, the ionized sample is injected into the ion mobility spectrometer (step 1108). After a specified time interval, the output of the electrometer array is read (step 1110). Finally, the output is analyzed to find the composition of the sample (step 1112). This analysis can be accomplished by comparing the output with recorded outputs from known samples.

Adjusting the Ions Mobility Spectrometer

FIG. 12 is a flowchart illustrating the process of adjusting parameters of the ion mobility spectrometer in accordance with an embodiment of the present invention. The system starts by establishing a laminar gas flow in the ion mobility spectrometer (step 1202). This laminar gas flow is adjusted to provide a Reynolds number of 1000 or less. A Reynolds number of over 1000 can be used if care is taken to maintain a laminar gas flow. Next, the system establishes an electric field that crosses the laminar gas flow (step 1204).

Finally, the system adjusts the laminar gas flow and the electric field to analyze the desired mobility range (step 1206). Note that when the system is used for particle mobility analysis, the gas flow is significantly lower than when used for ion mobility analysis, the electric field is stronger than when used for ion mobility analysis, or a combination of both lower gas flow and higher electric field.

Continuous Analysis

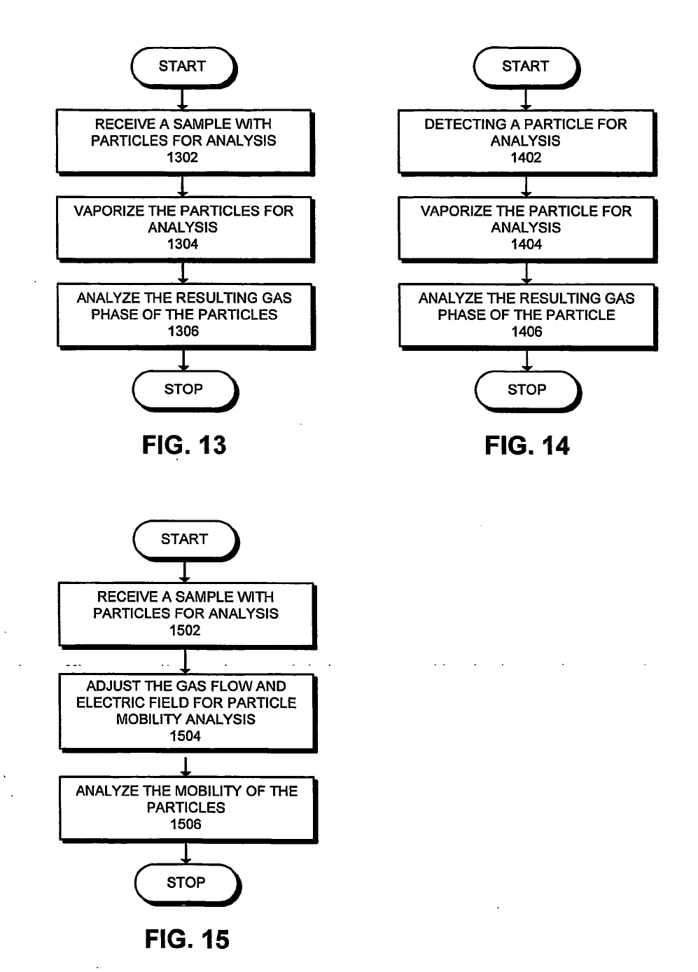

FIG. 13 is a flowchart illustrating the process of continuously converting particles to a gas-phase for analysis in accordance with an embodiment of the present invention. The system starts when a sample including particles for analysis is received (step 1302). Next, the system vaporizes the particles for analysis (step 1304). This vaporization can be accomplished by desorption, ablation, or a combination of desorption and ablation. Note that this is a continuous process. The sampling is performed by resetting the electrometer array and then reading the output of the electrometer array at a later time. Finally, the gas-phase of the particles is analyzed to determine the composition of the sample (step 1306).

Analyzing a Single Particle

FIG. 14 is a flowchart illustrating the process of converting a single particle to a gas-phase in accordance with an embodiment of the present invention. The system starts when a particle is detected for analysis (step 1402). Next, the system vaporizes the particle for analysis (step 1404). Note that vaporizing the particle can be accomplished by desorption or ablation. Finally, the system analyzes the resulting gas-phase of the particle (step 1406).

Particle Mobility Analysis

FIG. 15 is a flowchart illustrating the process of analyzing the mobility of particles in accordance with an embodiment of the present invention. The system starts when a sample is received for mobility analysis of the particles in the sample (step 1502). Next, the system adjusts the gas flow and electric field for particle mobility analysis (step 1504). Note that the gas flow is significantly lower than when used for ion mobility analysis, the electric field is stronger than when used for ion mobility analysis, or a combination of both lower gas flow and higher electric field is used. Finally, the system analyzes the mobility of the particles (step 1506). This analysis is accomplished as described above in conjunction with FIG. 8.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for performing ion mobility spectrometry, comprising:
receiving a sample for analysis;
ionizing the sample;
injecting the ionized sample into a laminar gas flow;
wherein an electric field crosses the laminar gas flow so that the laminar gas flow and the electric field combine to spatially separate ions of the sample based on ion mobility and so that the spatially separated ions contact different elements of an electrometer array,
reading an output of the electrometer array; and
analyzing the output to determine a chemical composition of the sample.

2. The method of claim 1, wherein receiving the sample for analysis involves:
receiving a plurality of particles for analysis; and
converting the plurality of particles into the gas-phase.

3. The method of claim 2, wherein converting the plurality of particles into the gas-phase involves desorbing at least one analyte from the plurality of particles.

4. The method of claim 2, wherein converting the plurality of particles into the gas-phase involves ablating at least one analyte from the plurality of particles.

5. The method of claim 2,
wherein the plurality of particles includes an individual charged particle; and
wherein particle mobility information related to the individual charged particle is detected by the electrometer array.

6. The method of claim 2, further comprising analyzing the sample with a first ion mobility spectrometer and a second ion mobility spectrometer in tandem, wherein:
the first ion mobility spectrometer receives ions that have been desorbed from the at least one analyte; and
the second ion mobility spectrometer receives ions that have been ablated from the at least one analyte;
whereby the first ion mobility spectrometer analyzes volatile compounds in the sample and the second ion mobility spectrometer analyzes non-volatile compounds in the sample.

7. The method of claim 1, wherein reading the output of the electrometer array involves:
resetting the electrometer array so that a charge on each element of the electrometer array is substantially zero;
accumulating charge on elements of the electrometer array for a given time; and
reading the charge on each element of the electrometer array.

8. The method of claim 1, wherein the sample is in a particle phase, and wherein the laminar gas flow and the electric field are adjusted to separate particle mobilities.

9. The method of claim 1, wherein performing ion mobility spectrometry involves using a separate electrometer array for positive ions and a separate electrometer array for negative ions.

10. The method of claim 1, wherein the electric field runs substantially perpendicular to the direction of the laminar gas flow.

11. An apparatus for performing ion mobility spectrometry, comprising:
a receiving mechanism configured to receive a sample for analysis;
an ionizing mechanism configured to ionize the sample;
an injecting mechanism configured to inject the ionized sample into a laminar gas flow;
wherein an electric field crosses the laminar gas flow so that the laminar gas flow and the electric field combine to spatially separate ions of the sample based on ion mobility and so that the spatially separated ions contact different elements of an electrometer array, a reading mechanism configured to read an output of the electrometer array; and
an analyzing mechanism configured to analyze the output to determine a chemical composition of the sample.

12. The apparatus of claim 11, wherein the receiving mechanism configured to:
receive a plurality of particles for analysis; and
convert the plurality of particles into the gas-phase.

13. The apparatus of claim 12, wherein converting the plurality of particles into the gas-phase involves desorbing at least one analyte from the plurality of particles.

14. The apparatus of claim 12, wherein converting the plurality of particles into the gas-phase involves ablating at least one analyte from the plurality of particles.

15. The apparatus of claim 12,
wherein the plurality of particles includes an individual charged particle; and
wherein particle mobility information related to the individual charged particle is detected by the electrometer array.

16. The apparatus of claim 12, further comprising a first ion mobility spectrometer and a second ion mobility spectrometer in tandem, wherein:
the first ion mobility spectrometer receives ions that have been desorbed from the at least one analyte; and
the second ion mobility spectrometer receives ions that have been ablated from the at least one analyte;
whereby the first ion mobility spectrometer analyzes volatile compounds in the sample and the second ion mobility spectrometer analyzes non-volatile compounds in the sample.

17. The apparatus of claim 11, wherein the reading mechanism is further configured to read the output of the electrometer array by:
resetting the electrometer array so that a charge on each element of the electrometer array is substantially zero;
accumulating charge on elements of the electrometer array for a given time; and
reading the charge on each element of the electrometer array.

18. The apparatus of claim 11, wherein the sample is in a particle phase, and wherein the laminar gas flow and the electric field are adjusted to separate particle mobilities.

19. The apparatus of claim 11, wherein performing ion mobility spectrometry involves using a separate electrometer array for positive ions and a separate electrometer array for negative ions.

20. The apparatus of claim 11, wherein the electric field runs substantially perpendicular to the direction of the laminar gas flow.

21. A means for performing ion mobility spectrometry, comprising:
a receiving means for receiving a sample for analysis;
an injecting means for injecting the ionized sample into a laminar gas flow;
wherein an electric field crosses the laminar gas flow so that the laminar gas flow and the electric field combine to spatially separate ions of the sample based on ion mobility and so that the spatially separated ions contact different elements of an electrometer array,
a reading means for reading an output of the electrometer array, and
an analyzing means for analyzing the output to determine a chemical composition of the sample.

22. The means of claim 21, wherein the receiving means:
receives a plurality of particles for analysis; and
converts the plurality of particles into the gas-phase.

23. The means of claim 22, further comprising a desorbing means for desorbing at least one analyte from the plurality of particles.

24. The means of claim 22, further comprising an ablating means for ablating at least one analyte from the plurality of particles.

25. The means of claim 22,
wherein the plurality of particles includes an individual charged particle; and
wherein particle mobility information related to the individual charged particle is detected by the electrometer array.

26. The means of claim 22, further comprising a first ion mobility spectrometer means and a second ion mobility spectrometer means in tandem, wherein:
the first ion mobility spectrometer means receives ions that have been desorbed from the at least one analyte; and
the second ion mobility spectrometer means receives ions that have been ablated from the at least one analyte;
whereby the first ion mobility spectrometer means analyzes volatile compounds in the sample and the second ion mobility spectrometer means analyzes non-volatile compounds in the sample.

27. The means of claim 21, wherein the reading means reads the output of the electrometer array by:
resetting the electrometer array so that a charge on each element of the electrometer array is substantially zero;
accumulating charge on elements of the electrometer array for a given time; and
reading the charge on each element of the electrometer array.

28. The means of claim 21, wherein the sample is in a particle phase, and wherein the laminar gas flow and the electric field are adjusted to separate particle mobilities.

29. The means of claim 21, wherein performing ion mobility spectrometry involves using a separate electrometer array for positive ions and a separate electrometer array for negative ions.

30. The means of claim 21, wherein the electric field runs substantially perpendicular to the direction of the laminar gas flow.
